(19) United States
(12) Patent Application Publication
(10) Pub. No.: US 2010/0025560 A1
(43) Pub. Date: Feb. 4, 2010

(54) Platform for accessories being instantly detachable from clothing

(76) Inventor: Jason R. Beck, Peoria, AZ (US)

Correspondence Address: BROWNSTEIN HYATT FARBER SCHRECK, LLP, 410 SEVENTEENTH STREET, SUITE 2200, DENVER, CO, 80202, US

(21) Appl. No.: 11/879,743

(22) Filed: Jul. 17, 2007

Related U.S. Application Data
(60) Provisional application No. 60/831,657, filed on Jul. 17, 2006.

(51) Int. Cl. F16M 13/00

(52) U.S. Cl. 248/558

(57) ABSTRACT

An apparatus comprising, in one embodiment, a first surface for attachment to an article of clothing, the first surface having at least one strap attached thereto operable to attach the first surface to the article of clothing; a second surface for attachment to an accessory, the second surface comprising at least one guide loop attached to the second surface, at least one cable operable to pass through said at least one guide loop and a portion of said accessory to attach said accessory to said second surface, and a handle attached to the at least one cable, wherein removal of the at least one cable detaches the accessory from the article of clothing. disclosed herein is a method for detaching an accessory from an article of clothing. In another embodiment, a method includes attaching a first surface of a platform to an article of clothing; attaching an accessory to a second surface of the platform by passing at least one cable through a portion of the accessory and by passing the at least one cable through a portion of the second surface; and removing the at least one cable from the portion of the second surface and from the portion of the accessory.

### CROSS REFERENCE TO RELATED APPLICATION

This application claims the benefit under 35 U.S.C. §119(e) of U.S. provisional patent Application No. 60/831,657 entitled “PLATFORM FOR ACCESSORIES BEING INSTANTLY DETACHABLE FROM CLOTHING” filed Jul. 17, 2006, the disclosure of which is hereby incorporated by reference in its entirety.

### BACKGROUND OF THE INVENTION

Protective vests are used in the military and law enforcement fields to provide a level of protection for military or law enforcement personnel when they come under fire. For example, military personnel must load different types of gear, such as weaponry, ammunition cartridges, communication equipment, medical supplies, water bottles, navigation equipment, and additional pouches of material to their protective vests in order to carry this gear in the field. Similarly, law enforcement personnel, such as SWAT team members, must often carry a variety of equipment on their vests when in the field. In addition, fishermen and outdoor enthusiasts often wear vests that can carry a load of equipment. During use, these vests can become quite heavy and cumbersome for the person wearing them.

As recognized by the present inventor, what is needed is an apparatus and method for a user to selectively and instantly detach an accessory that is attached to the user's vest.

### SUMMARY

According to one broad aspect of one embodiment of the present invention, disclosed herein is an apparatus comprising a first surface for attachment to an article of clothing, the first surface having at least one strap attached thereto operable to attach the first surface to the article of clothing; a second surface for attachment to an accessory, the second surface comprising at least one guide loop attached to the second surface, at least one cable operable to pass through the at least one guide loop and a portion of the accessory to attach the accessory to the second surface, and a handle attached to the at least one cable, wherein removal of the at least one cable detaches the accessory from the article of clothing.

In one example, the article of clothing is a vest having webbing, the at least one strap operable to be weaved through the webbing. For instance, the at least one strap may be attached to the first surface at a pivot end and the at least one strap may have an opposing free end with a securing member attached thereto operable to securely attach the free end of the strap to the first surface. The first surface may have webbing operable to receive the at least one strap, and the first surface may have a Velcro patch.

In one example, the second surface may include a guide channel loop for receiving the at least one cable, and the second surface may include a Velcro patch.

The at least one guide loop may include a plurality of loops, and the plurality of loops may be arranged in a U-shape if desired. The handle may include a handle body defining an interior channel housing the at least one cable, and the handle body may have a Velcro surface.

The at least one cable may have a first end and a second end, the first end operable to pass through a first set of guide loops, and a second end operable to pass through a second set of guide loops.

According to another broad aspect of another embodiment of the present invention, disclosed herein is a method for detaching an accessory from an article of clothing. In one embodiment, the method includes attaching a first surface of a platform to an article of clothing; attaching an accessory to a second surface of the platform by passing at least one cable through a portion of the accessory and by passing the at least one cable through a portion of the second surface; and removing the at least one cable from the portion of the second surface and from the portion of the accessory.

The method may also include, as part of the operation of attaching the first surface of the platform to the article of clothing, weaving the at least one strap through a portion of the article of clothing.

The method may also include, as part of the operation of attaching an accessory to a second surface of the platform, weaving the at least one cable through a portion of the accessory.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 illustrates an example of a cutaway platform having a cutaway handle, in accordance with one embodiment of the present invention.

FIG. 2 illustrates a rear view of the cutaway platform and handle of FIG. 1, in accordance with one embodiment of the present invention.

FIG. 3 illustrates a broken/sectional view of an example of a cutaway platform, in accordance with an embodiment of the present invention.

FIG. 4 illustrates an accessory (i.e., bag) attached to a cutaway platform which is attached to a vest, in accordance with one embodiment of the present invention.

FIG. 5 illustrates an example of an accessory (i.e., bag) attached to a vest through an example of a platform, in accordance with an embodiment of the present invention.

FIG. 6 illustrates an example of a cutaway platform having the cable of the cutaway handle inserted through the guide loops and guide channel of the platform, in accordance with one embodiment of the present invention.

FIG. 7 illustrates the platform and cutaway handle of FIG. 6, wherein the cutaway handle is pulled outwardly away from the platform and the cable moved out of the guide loops and guide channel, in accordance with an embodiment of the present invention.

FIG. 8 illustrates the platform separated from the cutaway handle/cable, in accordance with one embodiment of the present invention.

FIG. 9 illustrates an example of the front surface of an accessory bag, the front surface of the bag having PALS webbing thereon, in accordance with an embodiment of the present invention.

FIG. 10 illustrates an example of the rear surface of an accessory bag, in accordance with an embodiment of the present invention.

FIG. 11 illustrates a perspective view of an accessory bag in an open position, in accordance with one embodiment of the present invention.

### DETAILED DESCRIPTION

Disclosed herein are various embodiments of a platform that can be used to attach a variety of different accessories to a user's vest (such as tactical vests or load bearing vests used by military, police, security or the like), belt, drop-like panels, or other clothing or modular equipment, and if needed, the user can instantly cut-away or detach the accessory from the platform, thereby instantly detaching the accessory from the user's vest, belt, drop-like panel or other clothing.

For simplicity of this disclosure, a platform 20 will be shown and described as being attached to a vest 22, however, it is understood that the platform 20 could be attached to belts, drop-like panels, other clothing items, or modular equipment as desired. Also for simplicity, an accessory item 24 of a bag will be illustrated as being releasably attached to a platform; however, it is understood that virtually any accessory 24 could be attached to the platform 20, including, but not limited to, weaponry, ammunition cartridges, communication equipment, medical supplies, water bottles, food supplies, navigation equipment, other equipment, loads, pouches, ballistic plates, piston magazine pouches (including light and heavy machine gun pouches), ballistic carrying devices, batteries, or any accessory or item having PALS webbing thereon. Various embodiments of the present invention are described herein.

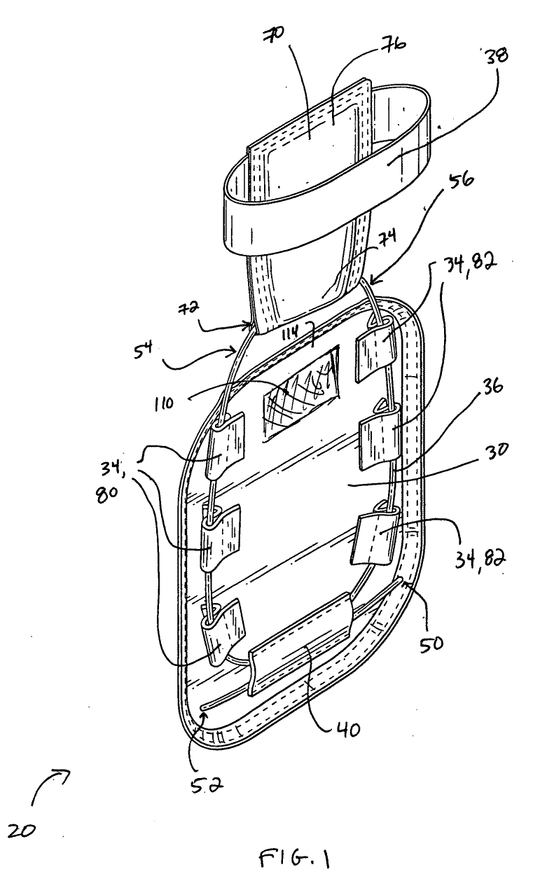

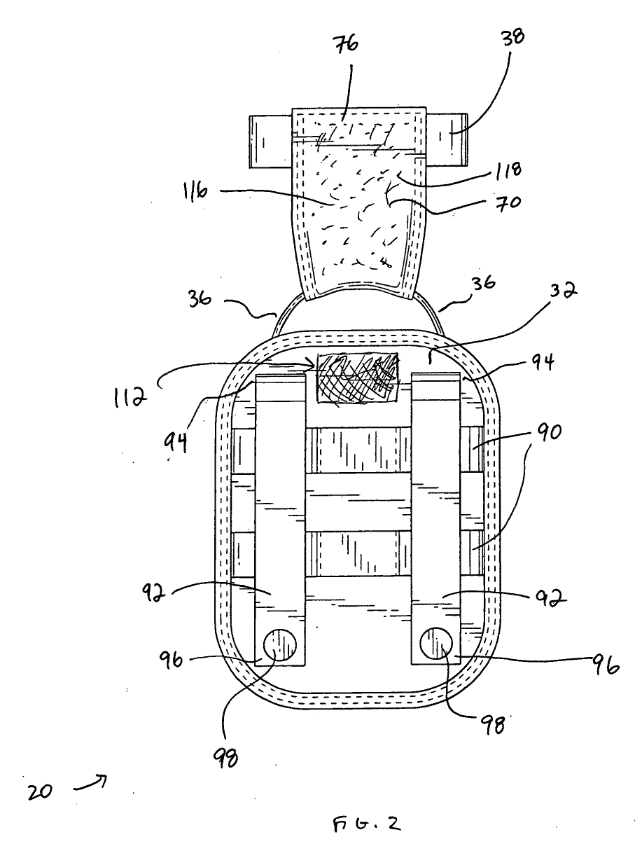

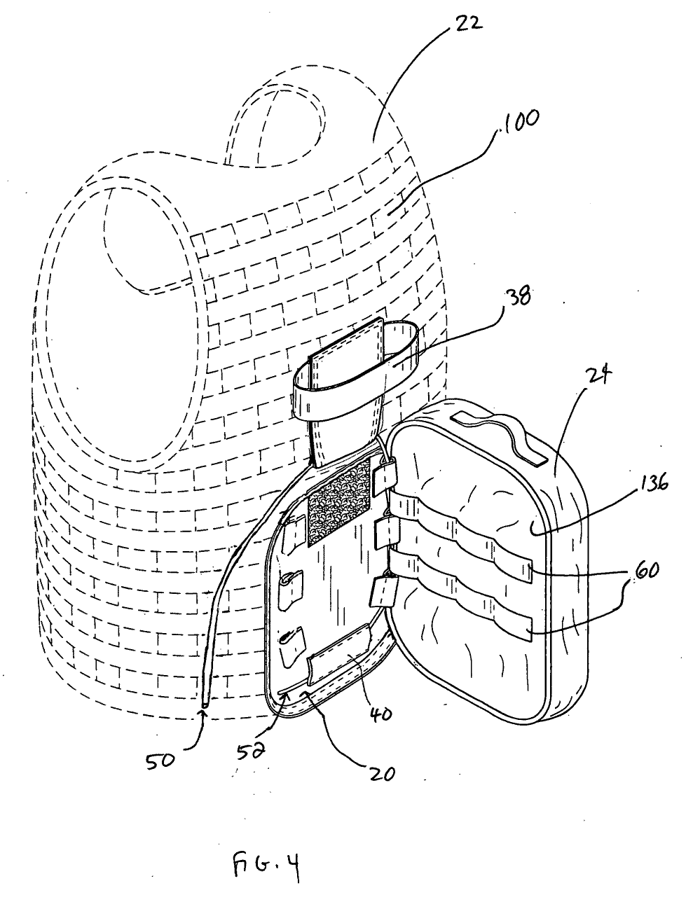

Referring to the figures, in FIG. 1 an example of a cutaway platform 20 is illustrated in accordance with one embodiment of the present invention. The platform 20 has a top surface 30 for attachment to an accessory 24 (FIGS. 1, 4, 5) and a bottom surface 32 for attachment to an article of clothing 22 (FIGS. 2, 4). One or more guide loops 34 are provided along the top surface 30 of the platform 20, the guide loops 34 for guiding and receiving at least one cable 36 which is attached to a cutaway handle 38. In one example, the guide loops 34 are cloth or nylon loops which are secured to the top surface 30 of the platform 20, and may be aligned along opposing sides of the top surface 30 of the platform 20 to generally form a U-shape in conjunction with a lower guide loop channel 40.

In one example, the surface 32 is attached to the article of clothing 22, and the surface 30 is attached to the accessory 24 (the order of these attachments can be reversed if desired).

For example, to attach surface 32 to an article of clothing 22 such as a vest, the least one strap 92 is attached to clothing 22. To attach surface 30 to accessory 24, the at least one cable 36 is operable to pass through the at least one guide loop 34 and a portion of the accessory 24 to attach the accessory 24 to surface 30,

Since the handle 38 is attached to the at least one cable 36, removal of the handle pulls the at least one cable 36 and can detach the accessory 24 from surface 30, which thereby detaches the accessory 24 from the article of clothing 22.

The guide loop channel 40 can be formed of an elongated material, in one example, that may be generally rectangularly shaped and extend along a portion of the lower end of the platform 20. In one example, the guide loop channel 40 adds resistance or friction to the cables after the ends 50, 52 of the first and second portions 54,56 of the cable 36 are inserted through the channel 40, which thereby helps maintain the cable 36 within or attached to the cutaway platform 20. The guide loops 34 are preferably spaced so that they fit between adjacent rows of PALS/Molle webbing 60 of the accessory 24, as will be described below. While the guide loops 34 are shown as loops made from rectangularly shaped materials, it is understood that other conventional loops or guides could be utilized, such as openings in the cutaway platform surface 30, plastic or metal rings, or any other conventional structure for receiving a cable 36.

As shown in FIGS. 1-2, a cutaway handle 38 is provided which is attached, through a handle body 70, to a cable 36, in one example. A single cable 36 may be provided wherein the single cable may be attached to the handle body 70 through an interior channel 72 formed at one end 74 (i.e., bottom end) of the handle body 70, wherein the opposing end 76 (i.e., top end) of the handle body 70 is attached with the cutaway handle 38. For instance, if the handle body 70 is formed from a single piece of material, the material can be folded in a U-shape, with the cable 36 being positioned at the interior channel 72 formed by the closed U-shape, and at the opposing end or open end 76 of the U-shape, the handle 38 can be positioned, and thereafter the handle body 70 can be secured in a closed position, such as by stitching or other conventional means. In one example, the handle 38 may be formed from a generally rectangular elongated piece of material that is secured to the handle body 70 to form an oval or ellipse, in one embodiment.

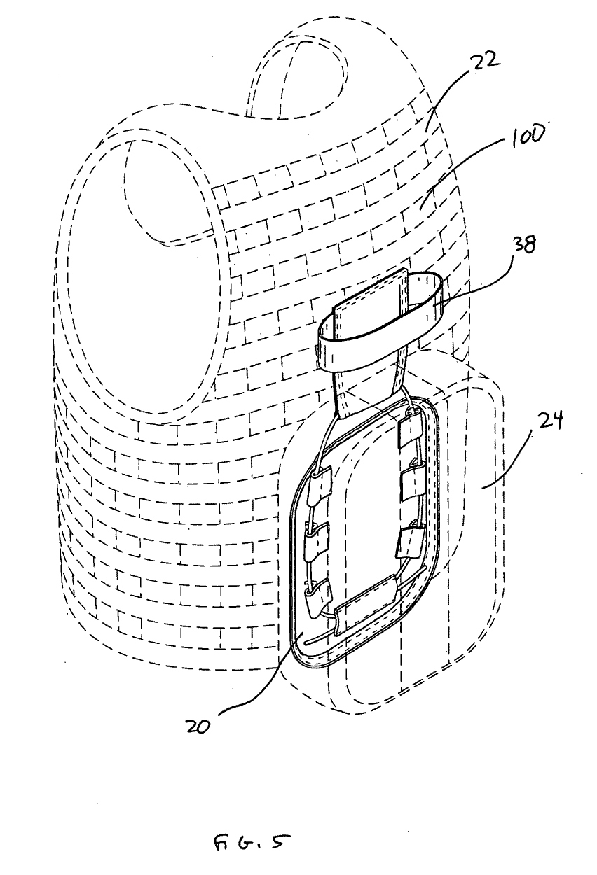

The cable 36 can be a single cable which is attached to the handle 38 through a handle body 70, in one example, or the cable 36 may include two separate cables emanating from the handle body, depending upon the implementation. The cable 36 can be a high tensile strength cable. In one example, a cable 36 has a first portion 54 of a cable which extends through a first set 80 of guide loops 34 terminating at end 50 through the guide loop channel 40; and the cable 36 also has a second portion 56 of the cable which travels through and is secured through a second set 82 of guide loops 34 terminating at end 52 through the guide loop channel 40, as shown in FIG. 1. In FIG. 2, an example of a bottom surface 32 of a platform 20 is illustrated, wherein the bottom surface 32 includes one or more strips 90 of PALS/molle webbing, oriented in a horizontal orientation in this example. The bottom surface 32 of a platform 20 may also include one or more vertically oriented straps 92 which are secured to the bottom surface such that the straps pivot at one end 94, and at the opposing end 96, have a snap 98 or other conventional securing member for securing the free end 96 of the strap to the bottom surface 32 of the platform 20. In one example, the female member of the snap 98 can be secured to the free end 96 of the strap 92, and the male end (not shown) of the strap 92 can be secured to the bottom surface of the platform 20. As will be described below, the free end 96 of the strap 92 attached to the bottom surface 32 of the platform 20 is adapted to be weaved in and out of the PALS webbing 100 of a vest 22 (FIGS. 4-5), as well as the PALS webbing 90 of the bottom surface 32 of the platform 20. In this way, the platform 20 may be securely attached to the vest 22 along the bottom surface 32 of the platform 20.

The straps 92 disclosed herein can include, if desired, a reinforcement layer along or within the elongated strap, which strengthens the strap 92 and keeps the strap 92 in a tight position during use when the strap 92 has been weaved through PALS webbing 90,100.

In one example, the top surface 30 of the platform 20 can be provided with a Velcro patch 110, positioned about the top edge 114 of the top surface 30 which is adjacent to the location of the handle body 70. The bottom surface 32 of the platform 20 can also be provided with a Velcro patch 112.

The handle body 70 may also be provided with the corresponding mating Velcro material 116 so that a portion of a bottom portion 118 of the handle body 70 may be secured to the Velcro patch 110 along the top surface 30 of the platform 20.

The handle body 70, being in one example a generally flexible member, can be folded over the top edge 114 of the platform 20 so that the underside 118 of the top end 76 of the handle body 70 attaches to the Velcro patch 112 on the bottom surface 32 of the platform 20. In this manner, the handle 38 can be tucked underneath the platform 20 during use so that it does not inadvertently get caught and pulled accidentally, but the handle 38 remains accessible to a user desiring to grab the handle 38 and pull upwardly thereon to release the accessory 24 and platform 20 from the vest 22.

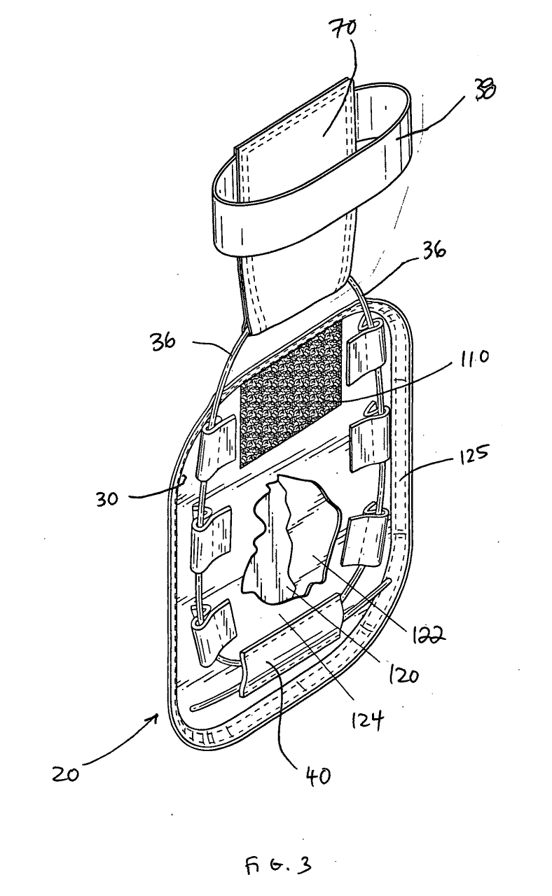

Referring to FIG. 3, in one example, the platform 20 may be formed having a slab or layer of inner board material 120 (such as plastic, polyurethane, cardboard, metal, armor, or any other conventional material preferably having some firmness or resiliency thereto), surrounded by a rear fabric layer 122 and a front fabric layer 124. In one example, the rear and front fabric layers 122,124 are made of nylon. The layers of fabric and the inner slab material 120 may be joined and secured together through conventional seam tape 125 or other conventional techniques.

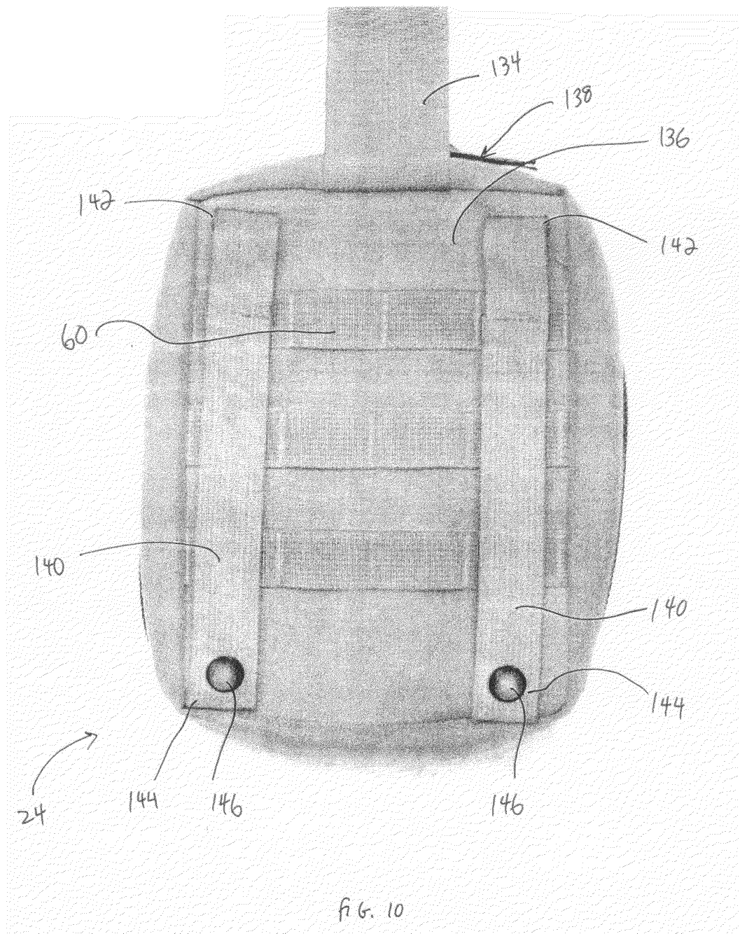

FIGS. 4-8 illustrate examples of a platform 20 securably attached to a vest 22 and releasably attached to an accessory 24 such as a bag. Examples of an accessory 24 such as a bag, are illustrated in FIGS. 9-11.

Referring to FIGS. 9-11, in one example, an accessory bag 24 may be provided with a front surface 130 having PALS/molle webbing 132 thereon for attachments of other items to the exterior front surface 130 of the accessory bag 24 if desired. A top strap 134 may be provided which can be used to tightly secure the front surface 130 of the accessory bag to the rear surface 136 of the accessory bag 24, for instance, through mating Velcro surfaces or other conventional attachment mechanisms having quick release characteristics. A zipper 138 may be provided with the accessory bag 24, in one example, the zipper 138 can be a two-headed zipper positioned along the sides of the accessory bag.

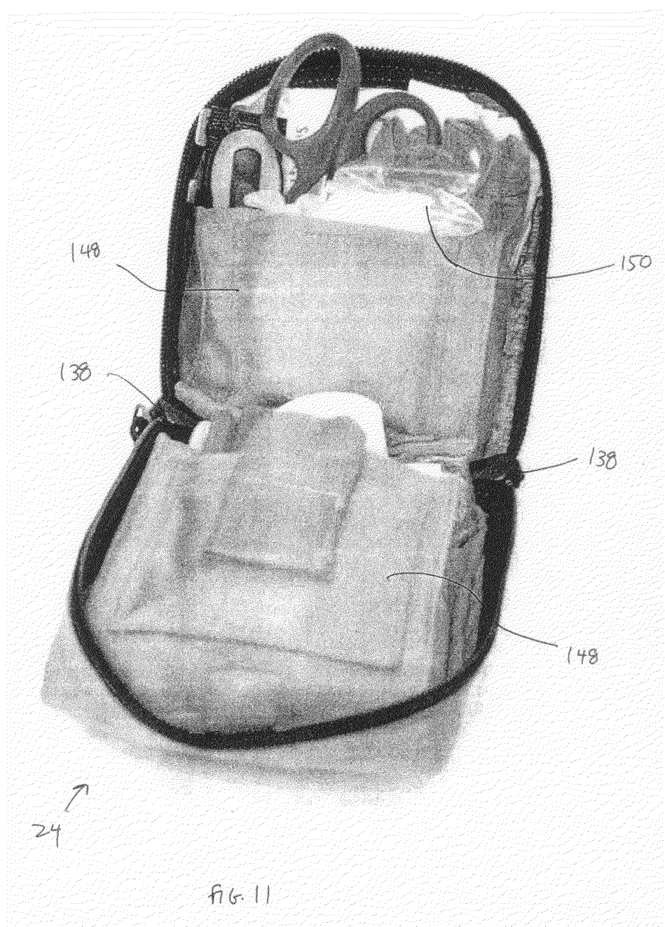

In FIG. 10, the rear surface 136 of an example of an accessory bag 24 is illustrated, the accessory bag 24 being provided with one or more strips 60 of PALS/molle webbing. As with the rear surface 32 of the platform 20(FIG. 2), the rear surface 136 of the accessory bag 24 (FIG. 10) can include one or more vertically oriented straps 140 having a fixed end attached to the rear surface 136 at a pivot point 142, and a free end 144 which may be weaved through the PALS/molle webbing of the rear surface 136 of the accessory bag 24 if desired. The free end 144 of the straps 140 may be secured to the rear surface 136 of the accessory bag 24 through a snap 146 or other conventional securement technique. In FIG. 11, an example of an accessory bag 24 in an open position is illustrated, having interior pockets 148 for storing accessories 150, in this case, medical supplies.

In use and as shown in FIGS. 4-8, the platform 20 can be secured, along its rear/backside 32, to a vest 22, belt, drop-like panel, or other articles of clothing or modular equipment. The attachment of the bottom surface 32 of the platform 20 to the vest 22 can be achieved by weaving each of the straps 92 of the bottom surface 32 of the platform 20 through the PALS webbing 100 of the vest 22 and if desired through the webbing 90 of the bottom surface 32 of the platform 20. Once the free end 96 of a strap 92 has been weaved through the respective PALS webbing 90,100, the free end of the strap is snapped and secured to the bottom surface 32 of the platform 20. In one example where two straps 92 are utilized on the bottom surface 32 of the platform 20, once the free end 96 of each strap 92 has been weaved through the webbing 90,100 and secured/snapped to the bottom surface 32 of the platform 20, then the platform 20 is secured to the vest 22. The platform 20 is now securely attached to the vest 22, and if desired, the platform 20 can be removed from the vest 22 only with considerable effort by the user, which would require unsnapping the securing member 98 and unweaving the straps 92 through the PALS webbing 90,100. Preferably the platform 20 is positioned and secured to the vest 22 in a location which will be permanent or semi-permanent, depending upon how the user intends to use the vest 22, the platform 20, and accessories 24 secured to the platform.

While the example of the platform 20 illustrated in FIGS. 1-2 has six guide loops 34 and one guide loop channel 40, it is understood that the number of guide loops 34,40 utilized is dependent upon the particular implementation. Also, while the platform 20 is shown utilizing, on its bottom/rear surface, two straps 92 and two strips 90 of PALS webbing, it is understood that a platform 20 could be formed utilizing fewer or greater numbers of straps 92 or strips 90 of PALS webbing depending upon the implementation.

Having attached the platform 20 securely to the vest 22, the accessory 24 that the user desires to attach to the platform 20 can then be releasably secured to the platform 20, in accordance with one embodiment of the present invention. As shown in FIG. 4, in one example, end 50 of a first portion 54 the cable 36 can be weaved through the guide loops 34,80 of the platform 20 and the PALS/molle webbing 60 of the underside 136 of the accessory 24, and the end 50 of the first portion 54 of cable 36 can be weaved through the lower guide loop channel 40. The other end 52 of a second portion 56 the cable 36 can then be weaved through the other set of guide loops 34,82 along the opposing edge of the platform 20 to connect the platform 20 to the opposing end of the PALS/molle webbing 60 of the accessory 24, and through the guide loop channel 40. When this is complete, the accessory 24 will be attached, releasably, to the platform 20 by virtue of both portions 54,56 of the cable 36 which have been weaved through the guide loops 80,82 of the platform and the PALS/molle webbing 60 of the underside 136 of the accessory 24, as is generally illustrated in FIG. 5.

If desired, the handle 38 shown in FIG. 5 can be tucked away by folding the handle body in a generally inverted U-shape over along the top edge 114 of the platform 20.

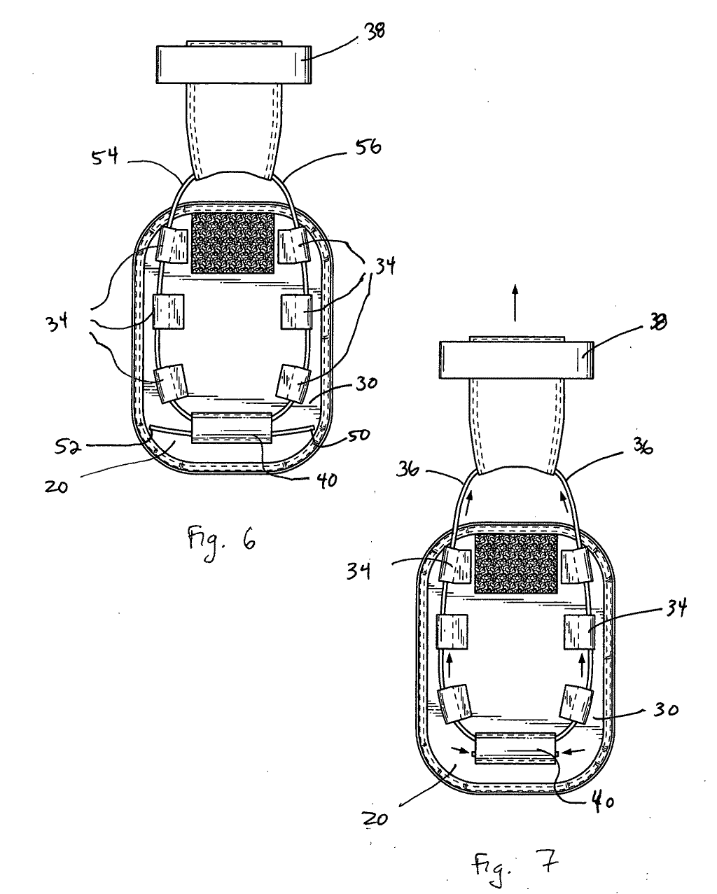

If the user or other person desires to selectively detach, immediately, the accessory 24 from the vest 22, the user or other person simply grabs the handle 38 and pulls the handle 38 outwardly away from the platform 20, which thereby unthreads the cable portions 54,56, thereby disconnecting the accessory 24 from the platform 20, as is shown in FIGS. 6-8.

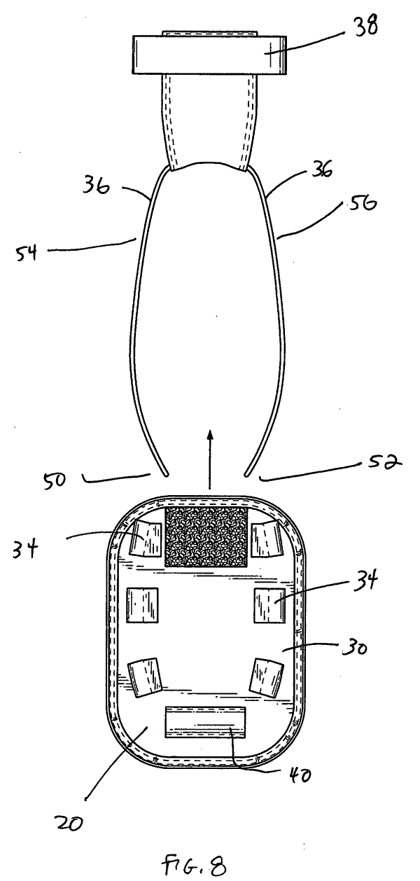

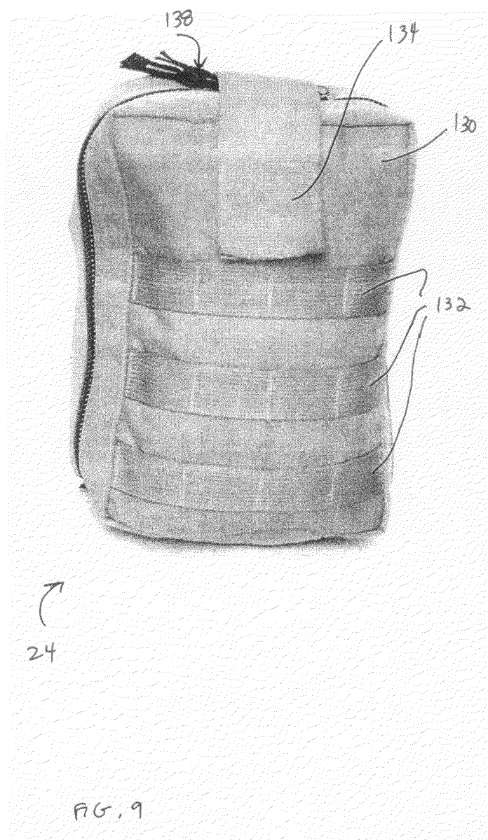

FIGS. 6-8 are representative figures showing the removal of the handle 38 from the platform 20. Although the accessory 24 is not shown in FIGS. 6-8 attached to the platform 20, it is understood that as the handle 38 is moved outwardly from the platform 20 as shown in FIGS. 7-8, the accessory 24 would be instantly detached from the platform 20 by virtue of the cable portions 54,56 no longer being weaved and threaded through the PALS webbing 60 of the underside 136 of the accessory 24 (see FIGS. 4, 5, 10).

Hence, stated differently, according to one embodiment, an apparatus 20 is disclosed comprising a first surface 32 for attachment to an article of clothing 22 such as a vest, the first surface 32 having at least one strap 92 attached thereto operable to attach the first surface 32 to the article of clothing 22; and a second surface 30 for attachment to an accessory 24, the second surface 30 comprising at least one guide loop 34 attached to the second surface 30, at least one cable 36 operable to pass through said at least one guide loop 34 and a portion of said accessory 24 to attach said accessory 24 to said second surface 30, and a handle 38 attached to the at least one cable 36, wherein removal of the handle removes the at least one cable 36 from the accessory 24 and thereby detaches the accessory 24 from second surface 3, which thereby detaches the accessory 24 from the article of clothing 22. Accordingly, it can be seen that embodiments of the present invention provide a platform 20 which, on one side 32, can be securely attached to a vest 22, belt, drop-like panel, or other clothing or equipment; and the other side 30 of the platform 20 can be releasably secured to various different accessories 24. In this way, the platform 20 secures the accessory 24 to the vest 22, belt, drop-like panel, other clothing or modular equipment. If the user or other person desires to quickly and immediately selectively detach the accessory 24 from the vest 22, the handle 38 is outwardly moved until the accessory 24 is freed from the platform 20.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. Inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. An apparatus, comprising:
a first surface for attachment to an article of clothing, the first surface having at least one strap attached thereto operable to attach the first surface to the article of clothing;
a second surface for attachment to an accessory, the second surface comprising:
at least one guide loop attached to the second surface,
at least one cable operable to pass through said at least one guide loop and a portion of said accessory to attach said accessory to said second surface, and
a handle attached to the at least one cable,
wherein removal of the at least one cable detaches the accessory from the article of clothing.

2. The apparatus of claim 1, wherein the article of clothing is a vest having webbing, the at least one strap operable to be weaved through the webbing.

3. The apparatus of claim 1, wherein the at least one strap is attached to the first surface at a pivot end, the at least one strap having an opposing free end with a securing member attached thereto operable to securely attach the free end of the strap to the first surface.

4. The apparatus of claim 1, further comprising:
webbing on the first surface operable to receive the at least one strap.

5. The apparatus of claim 1, further comprising:
a Velcro patch on the first surface.

6. The apparatus of claim 1, wherein the second surface includes a guide channel loop for receiving the at least one cable.

7. The apparatus of claim 1, wherein the second surface includes a Velcro patch.

8. The apparatus of claim 1, wherein the at least one guide loop includes a plurality of loops.

9. The apparatus of claim 8, wherein the plurality of loops are arranged in a U-shape.

10. The apparatus of claim 1, wherein the handle includes a handle body defining an interior channel housing the at least one cable.

11. The apparatus of claim 10, wherein the handle body has a Velcro surface.

12. The apparatus of claim 1, wherein the at least one cable has a first end and a second end, the first end operable to pass through a first set of guide loops, and a second end operable to pass through a second set of guide loops.

13. A method for detaching an accessory from an article of clothing, comprising:
attaching a first surface of a platform to an article of clothing;
attaching an accessory to a second surface of the platform by passing at least one cable through a portion of said accessory and by passing the at least one cable through a portion of said second surface; and
removing the at least one cable from the portion of the second surface and from the portion of the accessory.

14. The method of claim 13, wherein the operation of attaching the first surface of the platform to the article of clothing includes weaving the at least one strap through a portion of the article of clothing.

15. The method of claim 13, wherein the operation of attaching an accessory to a second surface of the platform includes weaving the at least one cable through a portion of the accessory.
